(19) United States
(12) Patent Application Publication
(10) Pub. No.: US 2010/0293047 A1
(43) Pub. Date: Nov. 18, 2010

(54) SYSTEM AND METHOD FOR OPTIMIZING PURCHASE OF INVENTORY FOR ONLINE DISPLAY ADVERTISING

(76) Inventors: HENRY SCHWARZ, Foster City, CA (US); Madhu Vudali, Santa Clara, CA (US); Katherine Inouye, San Francisco, CA (US); Ryan Christensen, San Francisco, CA (US)

Correspondence Address: COOLEY LLP;ATTN: Patent Group, Suite 1100, 777 - 6th Street, NW, WASHINGTON, DC, 20001, US

(21) Appl. No.: 12/780,845

(22) Filed: May 14, 2010

Related U.S. Application Data
(60) Provisional application No. 61/178,135, filed on May 14, 2009.

(51) Int. Cl. G06Q 30/00

(52) U.S. Cl. 705/14.42

(57) ABSTRACT

An ad network system for optimizing the purchase of online display advertisement inventory is disclosed. The ad network system includes an advertiser management system to manage and acquire data for a set of advertising campaigns for a set of advertisers and a publisher management system to manage and acquire data for inventory at publishers' sites and applications. A media buying system runs a two-part optimization to determine an allocation of available inventory and an inventory purchase plan based on the data acquired by the advertiser management system and the publisher management system.

### CROSS-REFERENCE TO RELATED APPLICATIONS

This application claims the benefit of U.S. Provisional Application No. 61/178,135, filed May 14, 2009, entitled “System and Method for Optimizing Purchase of Inventory for Online Display Advertising”, which is incorporated herein by reference in its entirety.

### BRIEF DESCRIPTION OF THE INVENTION

This invention relates generally to online display advertising. More particularly, this invention relates to techniques for optimizing the purchase of inventory for online display advertising.

### BACKGROUND OF THE INVENTION

Online display advertising is a popular form of advertising on the Internet that enables advertisers to communicate messages to their target audiences at an affordable cost. The advertiser's messages are communicated online via what's commonly referred to as “display ads”. Display ads may contain text, pictures, audio, video, or a combination of various types of media and interactive content. They may come in many forms and sizes and appear on web pages, search results, e-mails, text messages, online games, social network sites, and a host of other applications.

The multitude of sites on the Internet provides a thriving market for display ads. Participants in the market include advertisers, publishers, and users. The advertisers create the ads (sometimes with help from advertising agencies), and the publishers display the ads—along with content—to the users. By offering content that tends to cater to specific interests and demographics, the publishers enable advertisers to reach their target audience efficiently and effectively.

The advertisers' goal is to deliver a marketing message to their target audience, be it for brand awareness, to develop an emotional connection with the audience, to drive local sales, or for online conversion. For example, a car company may have display ads to build its brand around trust and safety, a pharmaceutical company may have display ads to market a certain drug using patients' stories, and a software company may have a display ad to convert users into buying a particular product.

Publishers, on the other hand, are concerned about growing their user base, page views (such as through repeat visits), and engagement with their users. They do so through organic growth due to their online brand (e.g., popular sites such as CNN.com, NYT.com, Facebook, etc.), by producing and publishing original content that attracts users, and by optimizing the placement of their sites in search engine results.

Publishers may also obtain revenue for their content by charging subscription fees to users or offering ad space to advertisers. Ultimately, users want to consume relevant, interesting content, find the information that would help them make a decision, and/or purchase goods and services online. With this in mind, publishers aim to display ads that are relevant and interesting to users and that lead to higher click-through rates, i.e., to higher user clicks on any given ad.

Publishers typically do not serve all the ads to the users themselves, but instead, rely on “advertising networks” to help with monetizing inventory that they cannot sell directly to advertisers. An ad network serves as an intermediary between publishers and advertisers to connect publishers that want to host ads to advertisers who want to run the ads. The ad network buys ad space or inventory from multiple publishers and re-sells them to the advertisers. The inventory may be in the form of “impressions”, which are defined as the display of advertising units on content requested by a user. Examples of ad networks include Doubleclick.com, Brand.net, and those offered by Google and Yahoo!, among others.

An ad network provides advertisers a “one-stop shop” where they can get the benefits of online display advertising, while avoiding the costs of having to negotiate deals with a large number of publishers individually. The ad network may offer advertisers the ability to run “advertising campaigns” with a guaranteed total number of impressions delivered over a given time period (or “flight”), with a desired mix of different site categories (or “channels”). Examples of typical channels may include “e-mail”, “sports”, and “lifestyles —women”, among others.

The ad network should not only ensure that the contractually guaranteed impression totals are delivered for a given advertising campaign, but also that other advertising campaign constraints specified by the advertisers are observed, including channel mix, smooth pacing or delivery over time, and audience segmentation (or “targeting”). For example, an advertiser may require that impressions (or some fraction of all delivered impressions) be from a given audience segment, e.g., “females—ages 25-44”. The ad network can also add value by ensuring impression delivery, quality standards, and other campaign performance metrics that may be of interest to the advertiser.

Advertising networks are therefore faced with the problem of deciding what specific inventory should be bought, given the collective obligation to the entire portfolio of advertising campaigns. This problem becomes complicated because inventory is fungible; impressions can be bought in bulk and then allocated to individual campaigns in any number of ways. The many different sites on the Internet vary widely in terms of the types of impressions they can deliver, both in terms of demographic composition and contextual classification (i.e., channel mix). Further complicating matters is that delivery rates for non-guaranteed (or class 2) inventory are uncertain and widely variable.

In addition, impressions from a given site may be purchased through a number of different sellers. Impressions may be purchased directly from the publisher of the site itself, or indirectly via an intermediary seller, often at differing costs and availability. A special type of indirect buy is referred to as a “blind” channel purchase. An example of a blind channel is the Yahoo! Communication Channel. When impressions are bought from the Yahoo! Communication Channel, the buyer receives impressions from any number of communications-related sites (e.g. email, messenger, or e-card sites), some of which are Yahoo! sites, but many of which are not.

Such a purchase is considered “blind” because the buyer does not know specifically on what sites delivery will occur. Blind purchases complicate the buying problem because the potential cost savings due to buying in the blind channel should be weighed against the possibility of receiving impressions on unusable sites.

With many campaigns running simultaneously—with overlapping flight dates, overlapping channels, and various targeting requirements—it is difficult, if not impossible, to manually determine a buy plan which meets all of the business goals at minimum cost. Furthermore, no scalable system that is capable of solving this problem in an effective manner is currently available.

Accordingly, it would be desirable to provide a system and method for ad networks to optimize the purchase of inventory for multiple advertising campaigns managed by an ad network.

### SUMMARY

An ad network system that optimizes the purchase of online display advertisement inventory is disclosed. The ad network system includes an advertiser management system to manage and acquire data for a set of advertising campaigns for a set of advertisers and a publisher management system to manage and acquire data for inventory at publishers' sites and applications. A media buying system runs a two-part optimization to determine both an allocation of available inventory and an inventory purchase plan based on the data acquired by the advertiser management system and the publisher management system.

An embodiment of the invention includes a method for optimizing the purchase of online display advertising in an ad network. Data for a set of advertising campaigns managed by the ad network is acquired. Inventory data for publishers' sites and applications in the ad network is further acquired. A set of inventory purchase requirements is determined for the set of advertising campaigns. One or more inventory lines are segmented along one or more dimensions to revise the set of inventory purchase requirements. An inventory purchase plan is generated to satisfy the set of inventory purchase requirements.

Another embodiment of the invention includes a two-part optimization module for optimizing the purchase of online display advertisement inventory in an ad network. The two-part optimization module includes an allocation optimization module and a buy plan optimization module. The allocation optimization module has linear programming executable routines to receive advertising campaign data and inventory data collected in the ad network, generate a set of inventory purchase requirements for the set of advertising campaigns, and revise the set of inventory purchase requirements by segmenting one or more inventory lines along one or more dimensions. The buy plan optimization module determines an inventory purchase plan to satisfy the set of inventory purchase requirements.

### BRIEF DESCRIPTION OF THE DRAWINGS

Embodiments of the invention are more fully appreciated in connection with the following detailed description taken in conjunction with the accompanying drawings, in which like reference characters refer to like parts throughout, and in which:

FIG. 1 illustrates an exemplary environment in which an ad network operates;

FIG. 2 illustrates a schematic diagram of exemplary advertising campaigns in accordance with an embodiment of the invention;

FIG. 3 illustrates a more detailed ecosystem in which an ad network operates in accordance with an embodiment of the invention;

FIG. 4 illustrates a schematic diagram of the Media Buying System of FIG. 3 in accordance with an embodiment of the invention;

FIG. 5 illustrates a flow chart for optimizing the purchase of inventory in the Media Buying System of FIG. 4 in accordance with an embodiment of the invention;

FIG. 6 illustrates a flow chart for implementing the Allocation Optimization Module in the Media Buying System of FIG. 4 in accordance with an embodiment of the invention;

FIG. 7 illustrates an exemplary schematic diagram for partitioning an inventory line in accordance with an embodiment of the invention;

FIG. 8 illustrates a flow chart for running the Buy Plan Optimization Module in Media Buying System of FIG. 4 in accordance with an embodiment of the invention; and

FIG. 9 illustrates a computer system for implementing the embodiments of the invention.

### DETAILED DESCRIPTION

A system and method for optimizing the purchase of inventory for online display advertising is provided. As generally used herein, a display advertisement or “display ad” may be any ad containing text, pictures, audio, video, or a combination of various types of media and interactive content for online display. Display ads may have many forms and sizes and appear on various sites and applications, such as web pages, search results, e-mails, text messages, online games, social network sites, and a host of other applications. The ads are created by advertisers and publishers display the ads—along with content—to users.

According to an embodiment of the invention, an ad network serves display ads to publishers to satisfy one or more advertising campaigns for one or more advertisers. The advertising campaigns are specified by a set of guarantees delivered over a given period of time (or “flight”) and subject to a set of qualifiers, constraints, quality controls, and business rules imposed by the advertisers. The guarantees may include a total number of impressions during the flight period or any other performance metric for delivering ads that may be of interest to the advertisers. An impression, as generally referred to herein, is the display of an ad to a user in a publisher's site or application. Also, a set, as generally referred to herein, is a collection of one or more objects.

Campaign qualifiers may include any designation that describes or qualify the ads in the campaign, such as, for example, the type of product advertised, a price for the product, an age-specific recommendation for the product, a gender recommendation for the product, and so on. Campaign constraints may include a specified channel mix, smoothness of delivery, audience segment, geographic segment, and so on. And quality controls may include any restriction on objectionable or undesirable content present in publishers' sites and applications.

In one embodiment, the campaign constraints, qualifiers, quality controls, and other attributes are used as inputs into an optimization module to determine optimized purchase requirements for a set of advertising campaigns such that campaign business goals and guarantees are met at minimum cost. The optimization module optimizes multiple campaigns simultaneously, allows flexible specification of various business rules and performance objectives, and automatically identifies efficiencies due to profitable segmentation of inventory along demographic and/or geographic dimensions.

As described in more detail herein below, the optimization module is run in two parts. The first part is dedicated to generating a set of optimal buy requirements, i.e., number and type of impressions, if any, that should be purchased for each campaign and channel in order to satisfy all campaign objectives, subject to its constraints, qualifiers, quality controls, and business rules. The second part determines an optimized buy plan, i.e., how many impressions to buy from specific publishers, so as to fulfill the buy requirements. Both parts are implemented to optimize an objective function, subject to equality and inequality constraints. It is appreciated that other optimization techniques can be implemented for other embodiments.

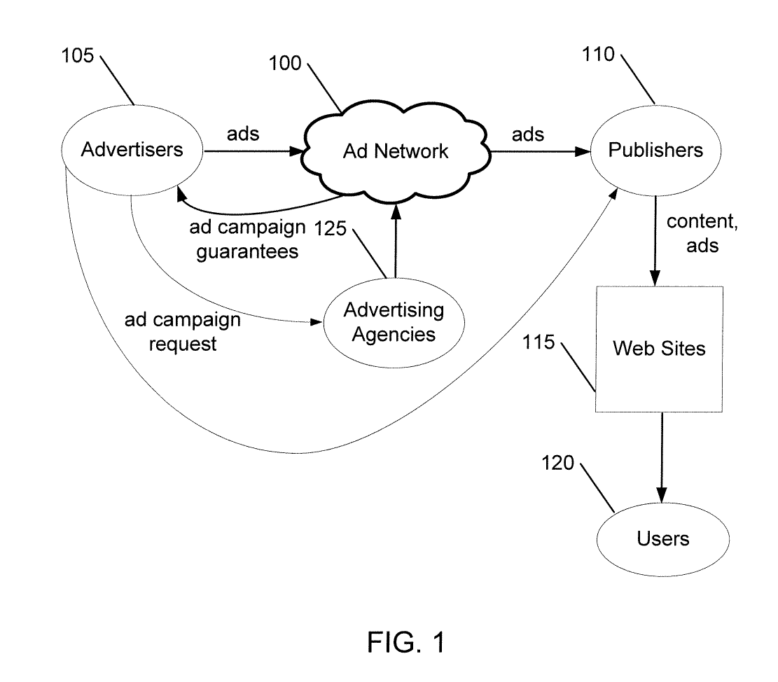

Referring now to FIG. 1, an exemplary environment in which an ad network operates is described. Ad network system 100 is an intermediary network between a set of advertisers 105 and a set of publishers 110. Advertisers 105 engage ad network system 100 to run advertising campaigns online by serving display ads to sites and applications operated by publishers 110, such as web pages (e.g., web pages 115), search engines, e-mails, text messages, online games, social network sites, and so on, that are viewed by users 120. Advertisers 105 may create the ads themselves and provide them to ad network system 100, or they may interact with one or more advertising agencies 125 to manage their advertising campaigns and create ads that most effectively achieve their marketing goals.

When advertisers 105 engage ad network system 100 to run their advertising campaigns, advertisers 105 may require ad network system 100 to abide by a set of campaign guarantees. Such guarantees may include, for example, a total number of impressions (or other performance metric) delivered over a flight period, with a desired mix of channels, with a specified pacing of delivery during the flight period, and for a particular audience segment. Advertisers 105 may also require that ad network system 100 run their advertising campaigns according to a set of campaign qualifiers, constraints, and quality controls.

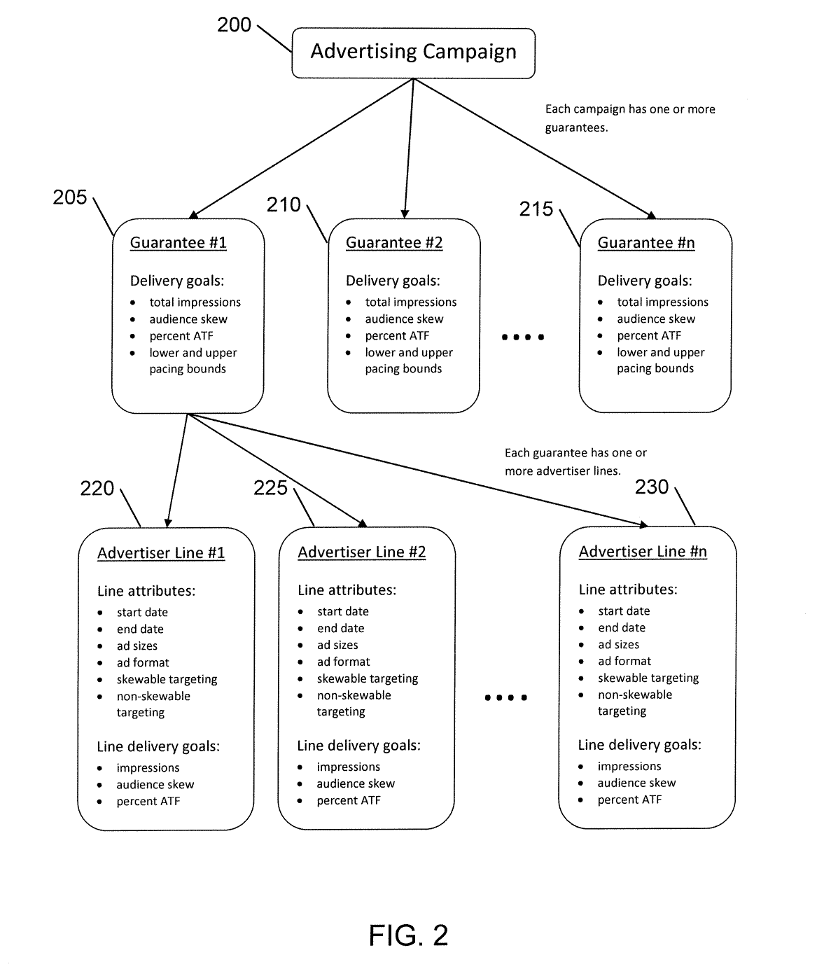

In one embodiment, advertising campaigns can be broken into one or more sets of impression targets, or guarantees, as illustrated in FIG. 2. Advertising campaign 200 may be segmented into multiple campaign guarantees 205-215, which, in turn, can be segmented into multiple advertiser lines 220-230. Each advertiser line specifies a set of attributes, such as a start and an end date for running the campaign, an ad format, and an associated channel, among others. For example, a November-December advertising campaign may have three separate impression guarantees—one for each month. Alternatively, a campaign may have one guarantee for one ad format (e.g. standard banner), and another guarantee for a different ad format (e.g. expandable banner).

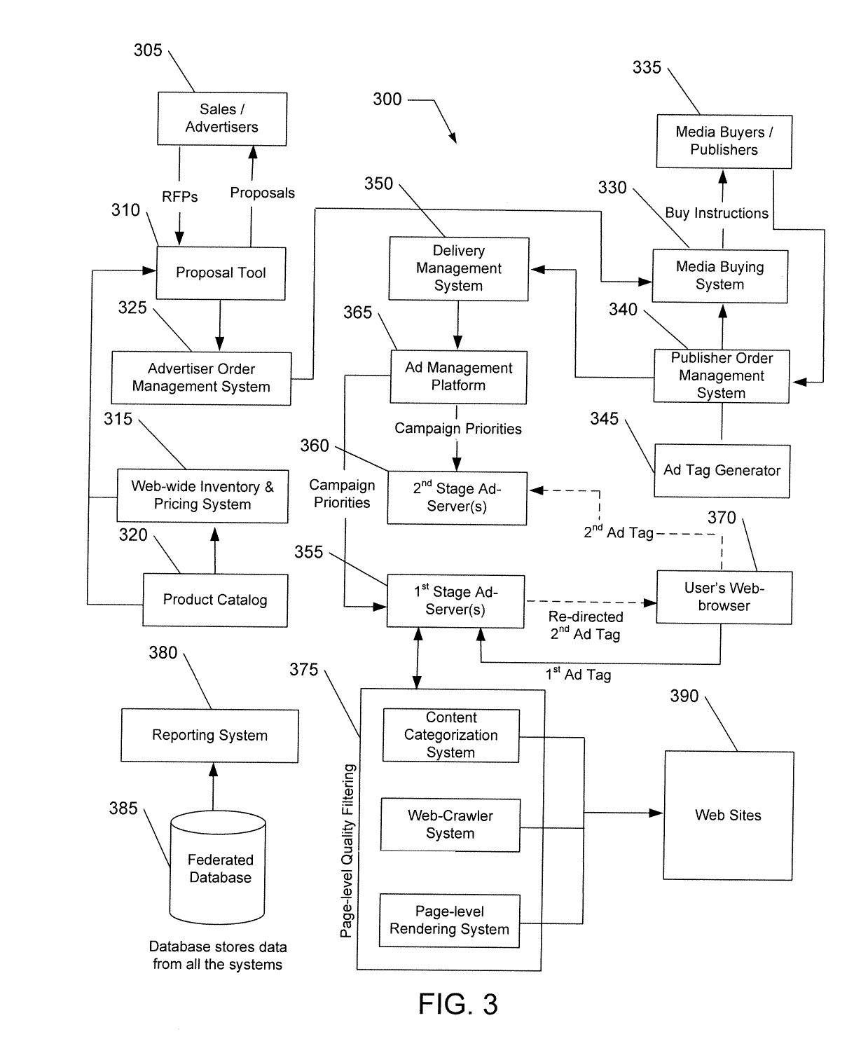

FIG. 3 illustrates a more detailed ecosystem in which an ad network system operates in accordance with an embodiment of the invention. Advertisers 305 may submit requests for proposals, or “RFPs”, to ad network system 300 to run one or more advertising campaigns for them. The RFPs are sent to Proposal Tool 310, which is a special purpose computer server for creating proposals for advertising campaigns. Proposal tool 310 submits the proposals to advertisers 305, specifying to advertisers 305 the campaign guarantees, constraints, and quality controls for each campaign.

In doing so, Proposal Tool 310 also checks Inventory and Pricing System 315 to forecast the availability of inventory (i.e., impressions on publisher's sites and applications) and an appropriate pricing structure for fulfilling a given advertising proposal for a given advertising campaign. The inventory and pricing forecast is determined based on the quality controls specified in the proposal for the campaign and according to Product Catalog 320, which defines the ads being sold by ad network system 300 to advertisers 305, specifying the available channels, the targeting criteria (e.g., demographic, geographic, and temporal), as well as the sizes (e.g., 728×900, 300×250 etc.) and formats (e.g., standard, rich media, video) of the ads. As understood by those skilled in the art, the pricing structure may be based on measures such as cost per impression (e.g., cost per a thousand impressions, or “CPM”), cost per click through, cost per action, cost per sale, or any other online advertising pricing model.

The advertising campaigns are managed by Advertiser Order Management System 325, which is a special purpose computer server for managing the campaigns during their delivery to publishers. All campaign qualifiers, constraints, and quality controls are stored and maintained in this system.

Once a proposal is established for a given advertising campaign, ad network system 300, through Media Buying System 330, makes optimized purchases of ad inventory, i.e., impressions, from publishers 335. Media Buying System 330, as described in more detail herein below, runs a two-part optimization module. The first part is dedicated to generating a set of optimal buy requirements, i.e., number and type of impressions, if any, that should be purchased for each campaign and channel in order to satisfy all campaign objectives, subject to its constraints, qualifiers, quality controls, and business rules. The second part determines a buy plan, i.e., how many impressions to buy from specific publishers so as to fulfill the buy requirements.

Media Buying System 330 sends purchasing instructions in the buy plan to media buyers 335, which then engage Publisher Order Management System 340 in ad network system 300 to manage the inventory purchases. The delivery of the inventory to ad network system 300 is managed by Delivery Management System 350, which maps the impressions sold by purchasers 335 to ad servers in ad network system 300 that serve the ads to be displayed in the impressions.

Delivery Management System 350 controls the delivery of inventory to ad network system 300 in order to meet the advertising campaign guarantees subject to its constraints, qualifiers, and guarantees, in an optimal manner. Delivery Management System 350 is the subject of the commonly owned, related patent application entitled “System for Optimizing Delivery for Online Display Advertising”, filed the same day as the present application, Application Serial No. ______, Attorney Docket No. BRAN-001/01US.

In accordance with an embodiment of the invention, ads are served by ad network system 300 in two stages, with two dedicated ad servers. The first stage is handled by First Stage Ad Server 355 and the second stage is handled by Second Stage Ad Server 360. Second Stage Ad Server 360 may also interact with a third-party Ad Management Platform 365 when serving the ads, such as the Doubleclick.com or Adtech.com platforms.

First Stage Ad Server 355 applies quality controls of the advertising campaigns before instructing Second Stage Ad Server 360 to serve the ads. An ad is served once a user places an ad call or ad request on a publisher's application, e.g., IM, e-mail, search engine, etc., or on a web browser, such as User's Web Browser 370. Upon receiving the ad call, First Stage Ad Server 355 sends the content of the page for analysis to Page-Level Content Categorization Module 375, which analyzes the page to determine whether it contains any objectionable content. First Stage Ad Server 355 then formats an appropriate response to the publisher's page or application, which then interacts with Second Stage Ad Server 360 to determine which of the eligible campaigns can serve the ad. In doing so, Second Stage Ad Server 360 may interact with a third-party ad serving system such as Doubleclick.com or Adtech.com.

Page-Level Content Categorization Module 375, as well as the process for serving the ads, are the subject of the commonly owned, related patent application entitled “System and Method for Applying Quality Controls to Online Display Advertising”, filed the same day as the present application, Application Serial No. ______, Attorney Docket No. BRAN-003/01US.

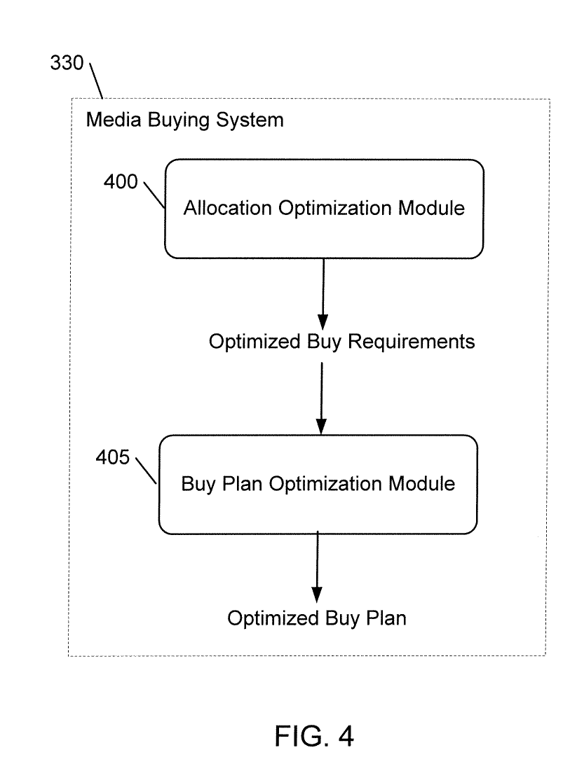

Referring now to FIG. 4, a schematic diagram of Media Buying System 330 in accordance with an embodiment of the invention is described. Media Buying System 330 receives as input the constraints, qualifiers, quality controls, and other attributes for a set of advertising campaigns managed by ad network 300. The inputs are used in a two-part optimization that determines optimized purchase requirements for the set of advertising campaigns such that campaign business goals and guarantees are met at minimum cost. The optimization is run for multiple campaigns simultaneously, allows flexible specification of various business rules and performance objectives, and automatically identifies efficiencies due to profitable segmentation of inventory along different demographic and/or geographic dimensions.

As described in more detail herein below, the optimization is run in two parts. The first part, implemented in Allocation Optimization Module 400, is dedicated to generating a set of optimal buy requirements, i.e., number and type of impressions, if any, that should be purchased for each campaign and channel in order to satisfy all campaign objectives, subject to its constraints, qualifiers, quality controls, and business rules. The second part, implemented in Buy Plan Optimization Module 405, determines how many impressions to buy from specific publishers so as to fulfill the buy requirements. Both parts are implemented to optimize an objective function, subject to equality and inequality constraints. The operations of Allocation Optimization Module 400 and Buy Plan Optimization Module are described herein below.

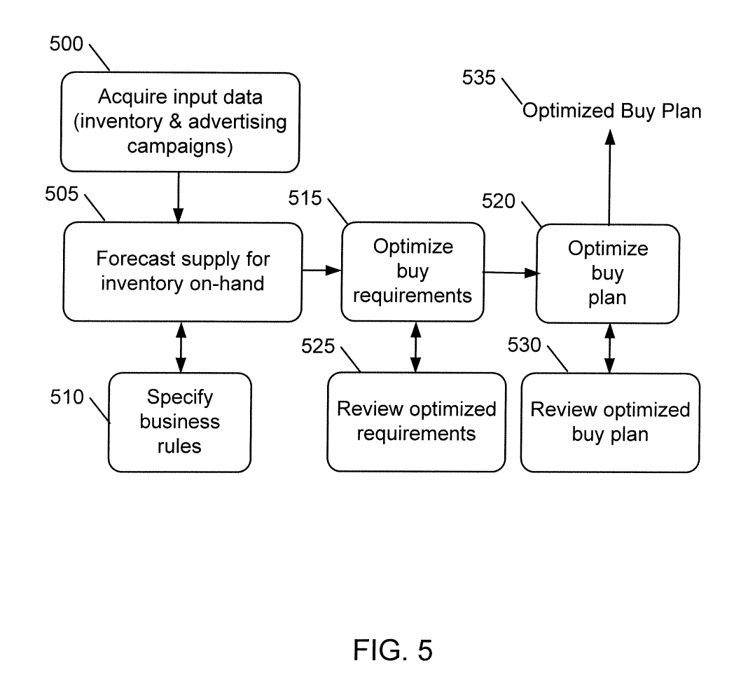

Referring now to FIG. 5, a flow chart for optimizing the purchase of inventory in Allocation Optimization Module 400 and Buy Plan Optimization Module 405 in Media Buying System 330 in accordance with an embodiment of the invention is described. The first step in optimizing the purchase of inventory is to assemble and store relevant input data for the optimization module in Media Buying System 330 (500). At a high level, this input data describes various aspects of supply (e.g., inventory already purchased and inventory that could be purchased) and demand (e.g., data on advertising campaigns and their requirements). The supply data is acquired by Publisher Order Management System 340 and the demand data is acquired by Advertiser Order Management System 325.

An exemplary set of input data (classified by type—either supply or demand) in accordance with an embodiment of the invention is shown in Table 1. It is appreciated that additional attributes of demand and/or supply besides those listed in Table 1 may be captured by Media Buying System 330.

TABLE 1
Input Data for Media Buying System 330

| Type | Data | Description |
|---|---|---|
| Supply | Inventory lines | Set of inventory purchases already made |
| Supply | Site(s) | Site(s) associated with each inventory line |
| Supply | Channel | Channel associated with each inventory line |
| Supply | Impression quantity | Total impressions booked for each inventory line |
| Supply | Flight dates | Start-end date for each inventory line |
| Supply | Ad sizes | Ad sizes for each inventory line |
| Supply | Ad format | Ad format for each inventory line |
| Supply | Targeting | Audience targeting (e.g. buy “gender = F” |
| | | impressions only), if any, associated with each |
| | | line |
| Supply | Line delivery | Impressions delivered to-date for each inventory |
| | | line |
| Supply | Line CPM | Actual cost per 1000 impressions for each |
| | | inventory line |
| Supply | Channel CPM | Expected CPM for each channel for a given |
| | | audience targeting |
| Supply | Site CPM | Expected CPM for each site for a given audience |
| | | targeting |
| Supply | Site control grade | Quality measure for each site |
| Supply | Site performance | Performance metrics (e.g. CPA, reach, |
| | metrics | frequency) associated with site |
| Supply | Site delivery rate | Percentage of bought impressions from a given |
| | | site that actually get delivered |
| Demand | Campaigns | Set of advertising campaigns |
| Demand | Guarantees | Set of guarantees within each campaign. Each |
| | | guarantee comprises one or more advertiser lines |
| Demand | Advertiser lines | Set of advertiser lines for each guarantee. Each |
| | | advertiser line has a start date, end date, ad |
| | | format, associated channel (e.g. “lifestyles - |
| | | women”), among other attributes |
| Demand | Guarantee targets | Targets for total impressions, demographic skew, |
| | | and above the fold (“ATF”) percentage. |
| Demand | Advertiser line targets | Targets at the advertiser line level for |
| | | impressions, demographic skew, and ATF |
| | | percentage |
| Demand | Flight dates | Start-end date for each advertiser line |
| Demand | Targeting | Audience targeting, if any, required by each |
| | | advertiser line |
| Demand | Control grade | Control grade requirement for each guarantee |
| Demand | Ad sizes | Ad sizes for each advertiser line |
| Demand | Ad format | Ad format for each advertiser line |
| Demand | Campaign delivery | Impressions delivered to-date for each advertiser |
| | | line, including percentage delivered in the |
| | | desired demographic target, as well as ATF |
| | | percentage |

The acquired input data is used to generate forecasts of impressions per day from inventory lines already purchased, broken down by ad size and (in the case of blind buys) delivered site (505). Forecasting impressions per day for inventory on-hand is important because even though a given number of impressions may be bought from a publisher, the number of impressions actually delivered may be variable and uncertain. The historical pattern of impressions delivered to-date on an inventory line can be used to estimate the number of impressions delivered in the future. In one embodiment, the impressions forecast is implemented as a time-series using a Kalman Filter. Other forecasting techniques may also be used.

Next, a user specifies business rules, model parameters, as well as inventory buys that are already in the pipeline but not yet stored in ad network system 300 (510). This is done through a web-enabled user interface (not shown) that allows remote users to interact with ad network system 300 in a distributed fashion. The web-enabled user interface displays the state of supply and demand data available in Publisher Order Management System 340 and Advertiser Order Management System 325.

In one embodiment, business rules specified by the user may include, but are not limited to, caps on the amount to buy for a given advertising campaign, flexibility of delivery with regard to channel level impression targets, upper and lower bounds on delivery pacing, priority ranking of campaigns, over-delivery goals, relative importance of reach and frequency, and overrides of forecasts generated in 505.

Once the business rules are specified, Media Buying System 330 runs the two-part optimization to (1) generate an optimal set of buy requirements (515) and (2) create an optimized set of buys—including impression amount, targeting, flight dates, among other attributes—that fulfill the buy requirements (520). In the first part, an optimal set of buy requirements, i.e. the number and type of impressions, if any, that should be purchased for each advertising campaign and channel, is generated in order to satisfy all campaign objectives, subject to business rules and the campaign constraints, qualifiers, and quality controls (515).

The role of the first part, implemented by Allocation Optimization Module 400, is to allocate existing supply (i.e., impressions that are already purchased) to demand so as to minimize the remaining need for additional impressions. After optimally allocating existing impressions to campaigns, the remaining need for impressions constitutes the optimized buy requirements.

In one embodiment, Allocation Optimization Module 400 treats the guarantee level goals as high priority constraints. That is, it recommends incremental buys in order to ensure that the guarantee goals can be met. The delivery goals at the advertising campaign guarantee level are derived from the delivery goals of the advertiser lines that belong to the guarantee.

In contrast, there is flexibility with regard to the line level goals. Each line level target includes a desired target level (lower priority), as well as a minimum lower bound (high priority). So long as the minimum lower bounds are satisfied, it is feasible to over-deliver to some lines while under-delivering to others. Allocation Optimization Module 400 tries to satisfy the desired target levels with available inventory, but may only recommend incremental buys if they are necessary to satisfy the minimum lower bound targets.

Once the optimal set of buy requirements is derived by Allocation Optimization Module 400, a user in ad network system 300 may review the buy requirements and make any necessary adjustments to business rules (525). For example, the user may decide that it is not worth buying any additional inventory for a given campaign if the buy requirements are too small. Alternatively, the user may decide that violating one or more business constraints may be acceptable for a given campaign. Any revisions to business rules should be followed by a re-run of Allocation Optimization Module 400 (515) to generate an updated set of optimized buy requirements.

Once the buy requirements are finalized, the user triggers the second part of the optimization (520) which generates an optimized buy plan (535) subject to user review (530). This part, implemented in Buy Plan Optimization Module 405, generates a fully specified set of buys, including impression amounts, demographic targeting, flight dates, and other attributes. Buy Plan Optimization Module 405 generates a minimum cost buy plan (535) that fulfills the buy requirements generated by Allocation Optimization Module 400 while also satisfying business rules associated with buying inventory, such as consolidating buys across publishers and/or flight dates where possible to minimize the number of buys, and observing minimum and maximum buy amounts. Allocation Optimization Module 400 and Buy Plan Optimization Module 405 are individually described in more detail herein below.

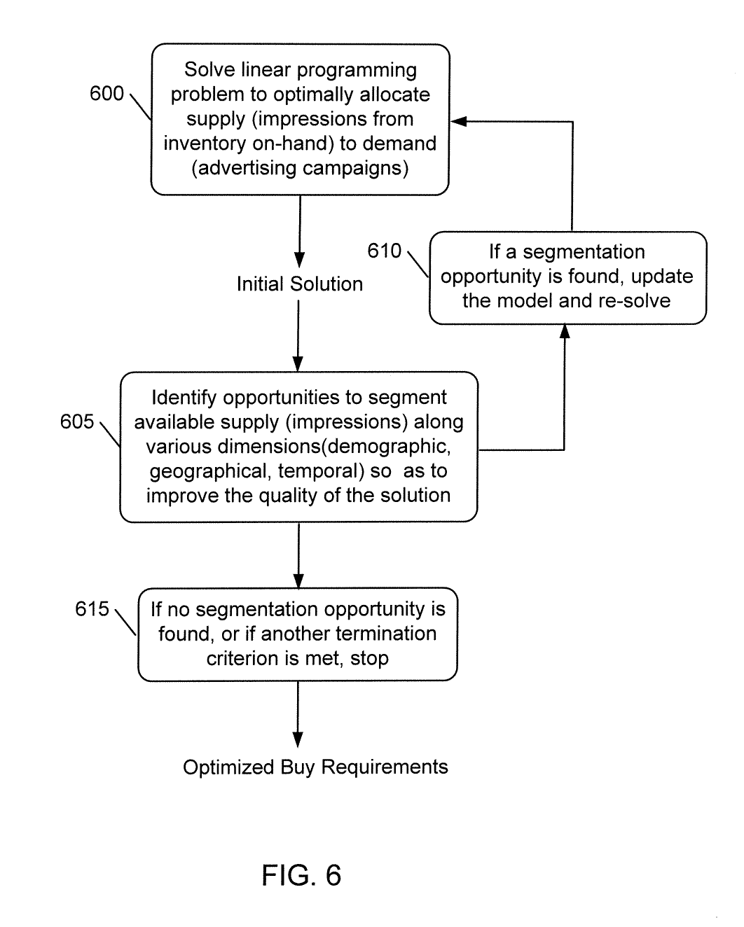

Referring now to FIG. 6, a flow chart for implementing Allocation Optimization Module 400 in accordance with an embodiment of the invention is described. In one embodiment, Allocation Optimization Module 400 can be formulated as a linear program that is automatically generated. The linear program objective is to minimize the cost of incremental inventory buys plus the sum of all penalties due to constraint violations.

The cost of incremental inventory buys is calculated from a set of inventory cost parameters (input data) and a set of buy requirement variables. Penalties are scalar values that are used to enforce business rules by penalizing constraint violations. There is also a penalty used to minimize the buy requirement for above the fold (“ATF”) impressions. The penalties are either small or large relative to the cost of buying additional impressions, depending on the relative importance of the given business rule. If impressions cost between 1 and 10 dollars per 1000 impressions, then appropriate penalty values (per impression) would be, for example, penalty^{small}=0.0005 and penalty^{large}=10.

If a large penalty is used in a constraint, then the optimization may recommend incremental inventory buys in order to avoid violating the constraint. If a small penalty is used, then the optimization may try to avoid violating the constraint, but may not recommend incremental spending to do so. In one embodiment, all guarantee level desired targets and line level lower bounds are enforced with large penalties, and all line level desired targets are enforced with small penalties.

The parameters (i.e., coefficients) and variables used in the linear program optimization are respectively listed below in Tables 2 and 3. All variables are constrained to be non-negative.

TABLE 2
Parameters for linear program formulation in Allocation Optimization Module 400

| Parameter | Description |
|---|---|
| daily_avail_imps_{s,t} | The number of impressions available from supply unit s on day t |
| imp_tgt_{g} | The impression target for advertiser guarantee g |
| imp_tgt_ub_{g} | The maximum impressions to be delivered to advertiser |
| | guarantee g |
| atf_tgt_{g} | The percentage of impressions that should be ATF for advertiser |
| | guarantee g |
| skew_tgt_{g} | The percentage of impressions that should be in the desired |
| | demographic target group for advertiser guarantee g |
| imp_tgtₗ | The impression target for advertiser line 1 |
| atf_tgtₗ | The percentage of impressions that should be ATF for advertiser |
| | line 1. In internet display advertising, an ATF impression is |
| | visible to the user without having to scroll down the page |
| skew_tgtₗ | The percentage of impressions that should be in the desired |
| | demographic target group for advertiser line 1 |
| imp_tgt_lbₗ | The minimum impressions to be delivered to advertiser line 1 |
| atf_tgt_lbₗ | The minimum percentage of impressions that should be ATF for |
| | advertiser line 1 |
| skew_tgt_lbₗ | The minimum percentage of impressions that should be in the |
| | desired demographic target group for advertiser line 1 |
| imp_dlvrdₗ | The total number of impressions delivered to date for line 1 |
| atf_dlvrdₗ | The percentage ATF delivered to date for line 1 |
| imp_dlvrd_in_tgtₗ | The number of in-target impressions delivered to date for line 1 |
| pacing_tgt_{g,t} | The desired number of impressions that should be delivered to |
| | advertiser guarantee g through end of day t |
| pacing_lb_{g,t} | The minimum number of impressions that should be delivered to |
| | advertiser guarantee g through end of day t |
| pacing_ub_{g,t} | The maximum number of impressions that should be delivered to |
| | advertiser guarantee g through end of day t |
| max_daily_buy_amt_{g} | The maximum number of impressions that can be bought for |
| | advertiser guarantee g per day |
| skew_cpmₗ | The cost per 1000 impressions of buying in-target (skewable) |
| | inventory for advertiser line 1 |
| nonskew_cpmₗ | The cost per 1000 impressions of buying non-skewable inventory |
| | for advertiser line 1 |
| inv_share_{s,p} | Partition p's share of impressions from supply unit s. Equals 1.0 |
| | when p is the null partition |
| prob_in_tgt_{s,p,l} | Fraction of impressions from (supply unit s, partition p) that are |
| | in-target for advertiser line 1. Equals 1.0 for advertiser lines that |
| | have no targeting requirement. This fraction captures the |
| | audience composition of the supply (e.g. “60% of impressions are |
| | female”), as well as potentially contextual composition (“25% of |
| | the impressions are classified as Sports”) |
| atf_pctₛ | Fraction of supply unit s impressions that are ATF |

TABLE 3
Variables for linear program formulation in Allocation Optimization Module 400

| Variable | Description |
|---|---|
| alloc_{s,p,l,t} | The number of impressions to be allocated from supply unit s, |
| | partition p to advertiser line 1 on time t |
| buy_req_total_{l,t} | Total number of impressions required to be bought for advertiser |
| | line 1 on day t |
| buy_req_skew_{l,t} | The number of impressions required to be bought for advertiser |
| | line 1 on day t that should be in the desired demographic target |
| | group |
| buy_req_nonskew_{l,t} | The number of impressions required to be bought for advertiser |
| | line 1 on day t that should not be in the desired demographic |
| | target group |
| buy_req_atf_{l,t} | The number of ATF impressions required to be bought for |
| | advertiser line 1 on day t |
| imp_tgt_lb_vltnₗ | Amount by which the impression target lower bound constraint is |
| | violated for advertiser line 1 |
| imp_tgt_vltnₗ | Amount by which the impression target constraint is violated for |
| | advertiser line 1 |
| skew_tgt_lb_vltnₗ | Amount by which the skew lower bound constraint is violated for |
| | advertiser line 1 |
| skew_tgt_vltnₗ | Amount by which the skew target constraint is violated for |
| | advertiser line 1 |
| atf_tgt_lb_vltnₗ | Amount by which the ATF lower bound constraint is violated for |
| | advertiser line 1 |
| atf_tgt_vltnₗ | Amount by which the ATF target constraint is violated for |
| | advertiser line 1 |
| pacing_lb_vltn_{g,t} | Amount by which the pacing lower bound constraint is violated |
| | for advertiser guarantee g and day t |
| pacing_ub_vltn_{g,t} | Amount by which the pacing upper bound constraint is violated |
| | for advertiser guarantee g and day t |
| pacing_tgt_pos_vltn_{g,t} | Positive violations of the pacing constraint for advertiser |
| | guarantee g and day t |
| pacing_tgt_neg_vltn_{g,t} | Negative violations of the pacing constraint for advertiser |
| | guarantee g and day t advertiser guarantee g through end of day t |

Furthermore, in solving for the linear program, the following indices are created:

1. Days tε{1, . . . , T}≡T, where 1 is the first day in the planning horizon, and t=T is the terminal period.

2. Inventory lines iε{1, . . . , I}≡I, where each I is the set of inventory lines already purchased.

3. Ad sizes aε(1, . . . , A)≡A, where A is the set of ad sizes (e.g. 300×250, 728×900) that may be required by advertisers and/or purchased from publishers.

4. Delivered sites dsε{1, . . . , DS}≡DS, where DS is the set of sites which may provide delivered impressions.

5. Units of supply sε{1, . . . , S}≡S, where each supply unit s is described by a (i,a,ds) tuple. In the case of blind channel buys, there will be multiple delivered sites ds for a given inventory line i. For non-blind buys, there will be a single delivered site ds for each inventory line i.

6. Advertiser guarantees gε{1, . . . , G}≡G, where each guarantee contains one or more advertiser lines.

7. Advertiser lines lε{1, . . . , L}≡L, where each advertiser line belongs to an advertiser guarantee.

8. Partitions pε{(0, 1, . . . , P}≡P, where each partition p describes a geographic or temporal segmentation of a piece of inventory, e.g. “state=California” and “day of week=Friday” are possible partitions (see FIG. 6). Partition p=0 is the NULL partition (i.e., no partitioning of the inventory).

9. Supply unit and partition pairs (s,p), which define how each supply unit can be segmented along geographic and/or temporal dimensions. Initially, each supply unit is assigned only the NULL partition p=0.

10. Advertiser guarantee and line pairs (g,l), which define which advertiser lines l comprise a given advertiser guarantee g.

11. Supply unit and day pairs (s,t), which define which days each supply unit is active.

12. Advertiser line and day pairs (l,t), which define which days each advertiser line is to run.

13. Supply unit and advertiser line pairs (s,l), which define which supply units are eligible to serve to each advertiser line. Typically, the subject matter of the site (e.g. “PCWorld.com”) is matched with the channel associated with the advertiser line (e.g. “Technology channel”). Also, the supply unit s should have an ad format that is compatible with the ad format required by advertiser line l. For example, if the advertiser line requires a video impression, the supply unit should yield video impressions.

The fully specified objective function Z minimized by Allocation Optimization Module 400 (600) is as follows:

$$\begin{matrix}Z = total cost of incremental inventory buys + \\ penalties due to violations of constraints \\ = sum ( \begin{matrix}( l , t ) , buy\_req {\_skew}_{l , t} * {skew\_cpm}_{l} + \\ buy\_req {\_nonskew}_{l , t} * {nonskew\_cpm}_{l}\end{matrix} ) / 1000 + \\ sum ( ( l , t ) , buy\_req {\_atf}_{l , t} * {penalty}^{small} ) / 1000 + \\ sum ( l , ( \begin{matrix}\begin{matrix}imp\_tgt \_lb {\_vltn}_{l} + \\ skew\_tgt \_lb {\_vltn}_{l} +\end{matrix} \\ atf\_tgt \_lb {\_vltn}_{l}\end{matrix} ) * {penalty}^{large} + \\ sum ( \begin{matrix}l , imp\_tgt {\_vltn}_{l} + skew\_tgt {\_vltn}_{l} + \\ atf\_tgt {\_vltn}_{l}\end{matrix} ) * {penalty}^{small} + \\ sum ( ( g , t ) , ( \begin{matrix}pacing\_lb {\_vltn}_{g , t} + \\ pacing\_ub {\_vltn}_{g , t}\end{matrix} ) * {penalty}^{large} + \\ sum ( ( g , t ) , ( \begin{matrix}pacing\_tgt \_pos {\_vltn}_{g , t} + \\ pacing\_tgt \_neg {\_vltn}_{g , t}\end{matrix} ) * {penalty}^{small}\end{matrix} \qquad ( 1 )$$

In one embodiment, the objective function Z may be minimized subject to the following constraints:

1. Supply Constraint #1—cannot allocate more impressions from a supply unit on a given day than the available supply. Only (supply unit, day) pairs in the set (s,t) are considered.

sum((p,l),alloc_{s,p,l,t}≦daily_avail_imps_{s,t}∀(s,t) (2)

2. Supply Constraint #2—cannot allocate more impressions from a partition of a supply unit on a given day than the available supply from that partition. Only (supply unit, partition) pairs that are in (s,p) are considered.

sum(l,alloc_{s,p,l,t})≦daily_avail_imps_{s,t}*inv_share_{s,p}∀(s,p),t (3)

3. Buy Requirement Relationship #1—the total buy requirement equals the buy requirement for “in-target” impressions plus the buy requirement for “out-of-target” impressions.

buy_req_total_{l,t}=buy_req_skew_{l,t}+buy_req_nonskew_{l,t}∀l,t (4)

4. Buy Requirement Relationship #2—the buy requirement for ATF impressions cannot be greater than the total buy requirement.

buy_req_atf_{l,t}≦buy_req_total_{l,t}∀l,t (5)

5. Guarantee Level Impression Target—a certain number of impressions should be delivered to each guarantee. For guarantee g, only advertiser lines that are in (g,l) are included in the summations.

sum(l,imp_dlvrdₗ)+sum((s,p,l,t),alloc_{s,p,l,t})+sum((l,t),buy_req_total_{l,t})≧sum(l,imp_tgtₗ)∀g (6)

6. Guarantee Level Impression Upper Bound—a maximum number of impressions should be delivered to a guarantee. For guarantee g, only advertiser lines that are in (g,l) are included in the summations.

sum(l,imp_dlvrclₗ)+sum((s,p,l,t),alloc_{s,p,l,t})+sum((l,t),buy_reg_total_{l,t})≦sum(l,imp_tgt_ubₗ)∀g (7)

7. Guarantee Level Skew Target—a desired percentage of all delivered impressions to each advertiser guarantee should be in the demographic/geographic/temporal targeting group specified for that line. For a guarantee g, only advertiser lines that are in (g,l) are included in the summations.

sum(l,imp_dlvrd_in_tgtₗ)+sum((s,p,l,t),alloc_{s,p,l,t}*prob_in_tgt_{s,p,l})+sum((l,t),buy_req_skew_{l,t})≧sum(l,(imp_dlvrdₗ+sum((s,p,t),alloc_{s,p,l,t})+sum(t,buy_req_total_{l,t}))*skew_tgtₗ)∀g (8)

8. Guarantee Level ATF Target—a desired percentage of all delivered impressions to each advertiser guarantee should be ATF. For a guarantee g, only advertiser lines that are in (g,l) are included in the summations.

sum(l,imp_dlvrdₗ*atf_deliveredₗ)+sum((s,p,l,t),alloc_{s,p,l,t}*atfp_pctₛ)+sum((l,t),buy_req_atf_{l,t})≧sum(l,(imp_dlvrdₗ+sum((s,p,t),alloc_{s,p,l,t})+sum(t,buy_req_total_{l,t}))*atf_tgtₗ)∀g (9)

9. Line Level Impression Target—a desired number of impressions should be delivered to each advertiser line.

imp_dlvrdₗ+sum((s,p,t),alloc_{s,p,l,t})+sum(t,buy_req_total_{l,t}+imp_tgt_vltn_{l,t})≧imp_tgtₗ∀l (10)

10. Line Level Skew Target—a desired percentage of all delivered impressions to each advertiser line should be in the demographic/geographic/temporal targeting group specified for that line.

imp_dlvrd_in_tgtₗ+sum((s,p,t),alloc_{s,p,l,t}*prob_in_tgt_{s,p,l})+sum(t,buy_req_skev_{l,t}+skew_tgt_vltn_{l,t})≧(imp_dlvrdₗ+sum((s,p,t),alloc_{s,p,l,t})+sum(t,buy_req_total_{l,t}))*skew_tgt_{l,t}∀l (11)

11. Line Level ATF Target—a desired percentage of all delivered impressions to each advertiser line should be above the fold.

(imp_dlvrdₗ*atf_deliveredₗ)+sum((s,p,t),alloc_{s,p,l,t}*atf_pctₛ)+sum(t,buy_req_atf_{l,t}+atf_tgt_vltn_{l,t})≧(imp_dlvrdₗ+sum((s,p,t),alloc_{s,p,l,t})+sum(t,buy_req_total_{l,t}))*atf_tgtₗ∀l (12)

12. Line Level Impression Lower Bound—a minimum number of impressions should be delivered to each advertiser line.

imp_dlvrdₗ+sum((s,p,t),alloc_{s,p,l,t})+sum(t,buy_req_total_{l,t}+imp_tgt_lb_vltn_{l,t})≧imp_tgt_lbₗ∀l (13)

13. Line Level Skew Lower Bound—a minimum percentage of all impressions delivered to each advertiser line should be in the demographic/geographic/temporal targeting group specified for that line.

imp_dlvrd_in_tgtₗ+sum((s,p,t),alloc_{s,p,l,t}*prob_in_tgt_{s,p,l})+sum(t,buy_req_skew_{l,t}+skew_tgt_lb_vltn_{l,t})≧(imp_dlvrdₗ+sum((s,p,t),alloc_{s,p,l,t})+sum(t,buy_req_skew_{l,t}+buy_req_nonskew_{l,t}))* skew_tgt_lbₗ∀l (14)

14. Line Level ATF Lower Bound—a minimum percentage of all impressions delivered to each advertiser line should be ATF.

(imp_dlvrdₗ*atf_deliveredₗ)+sum((s,p,t),alloc_{s,p,l,t}*atf_pctₛ)+sum(t,buy_req_atf_{l,t}+atf_tgt_lb_vltn_{l,t})≧(imp_dlvrdₗ+sum((s,p,t),alloc_{s,p,l,t})+sum(t,buy_req_total_{l,t}))*atf_tgt_lbₗ∀l (15)

15. Pacing Lower Bound Constraint—cumulative delivery to an advertiser guarantee should not be too far behind pace for a given advertiser guarantee g and day t. All summations are over advertiser lines l that are members of advertiser guarantee g, and days t2 where t2≦t.

sum(l,imp_dlvrdₗ)+sum((s,p,l,t2),alloc_{s,p,l,t2})+sum((l,t2),buy_req_total_{l,t2})+pacing_lb_vltn_{g,t}≧pacing_lb_{g,t}∀g,t (16)

16. Pacing Upper Bound Constraint—cumulative delivery to an advertiser guarantee should not be too far ahead of pace for a given advertiser guarantee g and day t. All summations are over advertiser lines 1 that are members of advertiser guarantee g, and days t2 where t2≦t.

sum(l,imp_dlvrdₗ)+sum((s,p,l,t2),alloc_{s,p,l,t2})+sum((l,t2),buy_req_total_{l,t2})−pacing_ub_vltn_{g,t}≦pacing_ub_{g,t}∀g,t (17)

17. Pacing Target Constraint—cumulative delivery to an advertiser guarantee should be as close to the pacing target as possible for any given advertiser guarantee g and day t.

sum(l,imp_dlvrdₗ)+sum((s,p,l,t2),alloc_{s,p,l,t2})+sum((l,t2),buy_req_total_{l,t2})+pacing_tgt_neg_vlin_{g,t}−pacing_tgt_pos_vltn_{g,t}=pacing_tgt_{g,t}∀g,t (18)

18. Maximum Daily Buy Constraint—the total daily buy requirement for a given advertiser guarantee should be less than a user specified amount. All summations are over advertiser lines 1 that are members of advertiser guarantee g.

sum(l,buy_req_total_{l,t})≦max_daily_buy_amt_{g}∀g,t (19)

It is appreciated that in the above formulation, the business constraints involving targeting (constraints Nos. 7, 10, and 13) can be expressed in terms of unique visitors, as opposed to number of impressions.

Solving the linear program specified above is the first step in Allocation Optimization Module 400 (600). At this point in the process, an initial solution can be passed along as the optimized buy requirements. In situations where there are few or no rigid targeting requirements for campaigns, this solution may be acceptable. However, sometimes campaigns have rigid targeting requirements, and in these cases the initial solution may not be optimal.

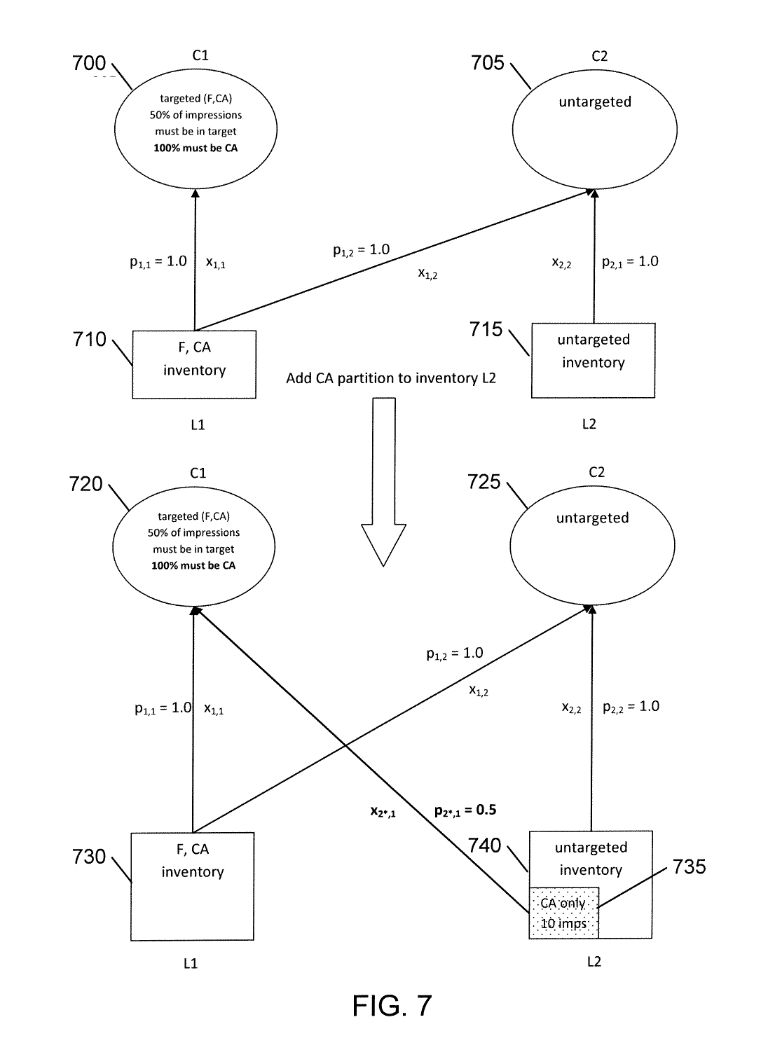

FIG. 7 illustrates why this is the case. Advertising campaign C1 requires that 50% of impressions allocated to it should be of the desired gender, which in this case is “Female”. The targeting requirements (700) are flexible with respect to gender (not all impressions must be female), but not so with respect to geography—all impressions must be from California. In contrast, advertising campaign C2 has no targeting requirements (705).

Suppose, for example, that there are two inventory lines from which impressions may be distributed to C1 and C2: inventory line L1 (710) and inventory line L2 (715). Inventory line L2 cannot deliver impressions to C1, since L2 has a mix of both CA and non-CA impressions. And inventory line L1 may not be able to fulfill the targeting requirements of advertising campaign C1. In this case, the initial solution found by Allocation Optimization Module 400 in FIG. 6 may therefore recommend an incremental purchase of CA-only inventory at some positive cost to guarantee that the targeting requirements of advertising campaign C1 are met.

A better solution is to recognize that inventory line L2 can be segmented such that CA impressions are identified at time of delivery and served specifically to advertising campaign C1, while untargeted impressions get allocated to advertising campaign C2. In one embodiment, this is called a partition of an inventory line. Partitions, such as partition 735 in inventory line L2, can be generated along those targeting requirements and campaign qualifiers that are knowable at time of impression delivery. Partitioning inventory lines can enable a feasible allocation to be found with zero incremental purchases required.

It is appreciated that when there are many advertising campaigns and inventory lines, each with different types of targeting (e.g., state, time of day, day of week), it may not be scalable to apply every possible partition to every inventory line due to the combinatorial explosion of the problem size.

Referring back to FIG. 6, Allocation Optimization Module 400 identifies partitions to improve the quality of the initial solution (605). This process can be repeated until no improving partitions are found or until some other termination criterion is met (615). In one embodiment, partitions are found by solving the Allocation Optimization linear program for an initial solution. Since the Allocation Optimization is formulated as a minimization problem, Allocation Optimization Module 400 leverages the fact that non-basic variables can be added to the basis if the reduced cost of the non-basic variables is negative.

It is appreciated that unidentified partitions can be viewed as identified partitions with zero impressions allocated to advertising campaigns. That is, unidentified partitions can be viewed as variables xᵢⱼ with value zero, i.e., not in the current basis. The question then becomes which of these variables, if any, should be added to the basis. Whether or not a given inventory line should be partitioned along a given dimension (e.g., CA/non-CA) can therefore be determined by computing the reduced cost of the proposed partition. The reduced cost computation involves the shadow prices (also called marginal values) obtained from solving the linear program optimization 600, as well as the targeting characteristics of the inventory line in question (i.e., the inv_share_{s,p} values for the given inventory line and candidate partition).

In one embodiment, candidate partitions are evaluated by computing:

reduced_cost_{s,p,l,t}=−π_{s,p,l,t}a_{s,p,l,t} (20)

where π_{s,p,l,t} is the vector of shadow prices associated with the tuple (supply unit s, candidate partition p, inventory line l, day t) obtained from solving a linear programming problem to minimize the objective function c^{T}x subject to Ax=b, where x represents the vector of variables (to be determined), c and b are vectors of (known) parameters and a_{s,p,l,t} is the vector of A matrix coefficients associated with the tuple (s,p,l,t).

Reduced costs can be computed for any (s,p,l,t) tuple that is not already in the linear programming problem. If all reduced costs are non-negative, then there are no improving partitions and Allocation Optimization Module 400 is done. Any negative reduced_cost_{s,p,l,t} indicates that adding variable alloc_{s,p,l,t} to the problem improves the solution.

The partition(s) with the most negative reduced costs are added to the linear program optimization 600 by (1) creating a new variable alloc_{s,p,l,t} representing the allocation of impressions from the partitioned inventory line to the targeted campaign, and (2) adding a new constraint to the linear program optimization 600 to ensure that available impressions are allocated once and only once.

The process of solving the linear program optimization 600 and then evaluating reduced costs for candidate partitions is repeated until all reduced costs are positive, the rate of solution improvement gets too small, or the total solution time gets too large. At this point, Allocation Optimization Module 400 is finished. As illustrated in FIG. 5, a user in ad network system 300 may then review the buy requirements and make any necessary adjustments to business rules (525). Any revisions to business rules should be followed by a re-run of Allocation Optimization Module 400 (515) to generate an updated set of optimized buy requirements. Once the buy requirements are finalized, the user triggers Buy Plan Optimization Module 405 (520) to generate an optimized buy plan (535) subject to user review (530).

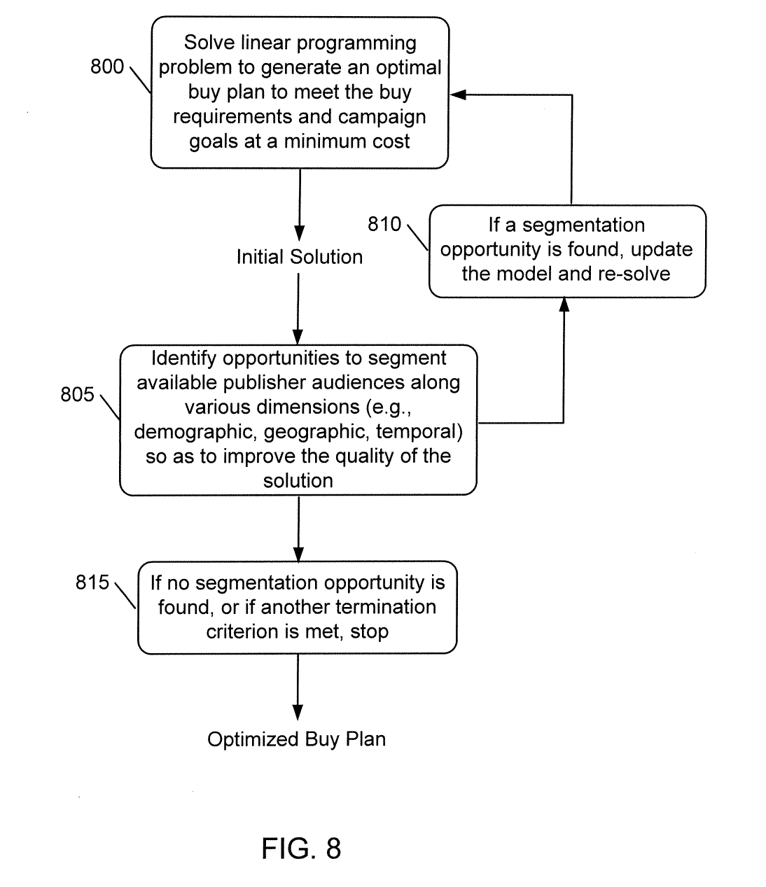

Referring now to FIG. 8, a flow chart for running Buy Plan Optimization Module 405 in Media Buying System 330 in accordance with an embodiment of the invention is described. Buy Plan Optimization Module 405 generates a minimum cost buy plan that fulfills the buy requirements generated by Allocation Optimization Module 400, while also satisfying business rules associated with buying inventory, such as consolidating buys across publishers and/or flight dates where possible to minimize the number of buys, and observing minimum and maximum buy amounts.

Buy Plan Optimization Module 405 is set up as a mixed integer program, with the goal to minimize a total purchase cost (800). The parameters and variables used in the mixed integer program formulation are respectively listed in Tables 4 and 5. All continuous variables are constrained to be non-negative.

TABLE 4
Parameters for mixed integer program formulation in Buy Plan Optimization
Module 405

| Parameter | Description |
|---|---|
| cpm_{b} | The cost per 1000 impressions for candidate buy b |
| buy_req_total_{l,t} | The total number of impressions to be bought for advertiser line |
| | 1 on day t. This is an output of Allocation Optimization Module |
| | 400 |
| buy_req_skew_{l,t} | The number of “in-target” impressions to be bought for |
| | advertiser line 1 on day t. This is an output of Allocation |
| | Optimization Module 400 |
| buy_req_nonskew_{l,t} | The number of “out-of-target” impressions to be bought for |
| | advertiser line 1 on day t. This is an output of Allocation |
| | Optimization Module 400 |
| buy_req_atf_{l,t} | The number of above the fold (ATF) impressions to be bought |
| | for advertiser line 1 on day t. This is an output of Allocation |
| | Optimization Module 400 |
| delivery_rate_{b} | The expected delivery rate for candidate buy b. This is the |
| | fraction of purchased impressions that are expected to actually |
| | be delivered by the publisher. |
| usable_share_{b,l} | The fraction of impressions from candidate buy b that are |
| | usable for advertiser line 1. This value captures wasted |
| | impressions due to blind channel buys. |
| inv_share_{b,p} | Partition p's share of impressions from candidate buy b. Equals |
| | 1.0 when p is the null partition. |
| prob_in_tgt_{b,p,l} | Fraction of impressions from (candidate buy b, partition p) that |
| | are in-target for advertiser line 1. Equals 1.0 for advertiser lines |
| | that have no targeting requirement. This fraction captures the |
| | audience composition of the supply (e.g. “60% of impressions |
| | are female”). |
| atf_pct_{b} | Fraction of impressions from candidate buy b that are above the |
| | fold. |
| max_num_purchase_orders | Maximum number of purchase orders allowed. |
| min_site_breadthₗ | Minimum site breadth for advertiser line 1. |
| num_days_{b} | The flight length (in days) for candidate buy b. |

TABLE 5
Variables for mixed integer program formulation
in Buy Plan Optimization Module 405

| Variable | Description |
|---|---|
| buy_{b} | The number of impressions per day to be bought from |
| | candidate buy b. (continuous variable) |
| alloc_{b,p,l,t} | The number of impressions from (candidate buy b, partition p) |
| | to be allocated to advertiser line 1 on day t. Variable is fixed |
| | at zero for any candidate buy that is ineligible to serve to |
| | line 1 due to invalid site, ad size, or ad format. (continuous |
| | variable) |
| Yᵤ | Equals 1 if there is a purchase from publisher u, 0 otherwise. |
| | (binary variable) |
| Z_{s,l} | Equals 1 if site s is bought for advertiser line 1, 0 otherwise. |
| | (binary variable) |

Further, the following indices are used:

1. Days tε{1, . . . , T}≡T, where 1 is the first day in the planning horizon, and t=T is the terminal period.

2. Advertiser lines lε{1, . . . , L}≡L, where L is the set of lines that have a positive buy requirement.

3. Sites sε{1, . . . , S}≡S, where S is the set of sites that may be bought. In this context, a “site” can be either a website that delivers impressions, or a blind channel (e.g., Yahoo! Communications channel) that would deliver impressions on a mix of websites.

4. Ad sizes aε{1, . . . , A}≡A, where A is the set of ad sizes (e.g. 300×250, 728×900) that may be required by advertisers and/or purchased from sellers.

5. Ad formats of afε{1, . . . , AF}≡AF, where AF is the set of ad formats (e.g. standard banner, expandable banner, video) that may be required by advertisers and/or purchased from sellers.

6. Publishers uε{1, . . . , U}≡U, where U is the set of publishers from which inventory can be purchased.

7. Start dates dε{1, . . . , D}≡D, where D is the set of start dates associated with L.

8. Flight duration fε{1, . . . , F}≡F, where F is the set of possible flight lengths (in days) that could be purchased from publishers.

9. Targeting options Rε{1, . . . , R}≡R, where R is the set of targeting options that may be purchased from publishers (e.g. purchase “gender=Male” inventory).

10. Candidate buys bε{1, . . . , B}≡B, where B is the set of possible buys, and each b is a (s,a,d,f,r) tuple.

11. Partitions pε{0, 1, . . . , P}≡P, where each partition p describes a geographic or temporal segmentation of a candidate buy, e.g. “state=California” and “day of week=Friday” are possible partitions. Partition p=0 is the NULL partition (i.e. no partitioning of the inventory).

12. Candidate buy and partition pairs (b,p), which define how each candidate buy is segmented along geographic and/or temporal dimensions. Initially, each candidate buy b is assigned only the NULL partition p=0.

13. Site, ad size, ad format and advertiser line tuples (s,a,af,l), which define which (site, ad size, ad format) combinations are eligible to serve to each advertiser line.

14. Candidate buy and day pairs (b,t), which define which days each candidate buy is active.

15. Advertiser line and day pairs (l,t), which define which days each advertiser line is to run.

16. Publisher and site pairs (u,s), which define which publishers own which sites.

In one embodiment, the total purchase cost Z that is minimized is as follows:

z=total purchase cost=sum(b,buy_{b}*cpm_{b}*num_days_{b})/1000(21)

The total purchase cost Z in Equation (21) may be minimized subject to the following constraints:

1. Supply Constraint #1—cannot allocate more impressions from a supply unit on a given day than the available supply. Only (candidate buy, day) pairs in the set (b,t) are considered.

sum((p,l),alloc_{b,p,l,t}≦buy_{b}*delivery_rate_{b}∀(b,t) (22)

2. Supply constraint #2—cannot allocate more impressions from a partition of a buy on a given day than the available supply from that partition. Only (candidate buy, partition) pairs that are in (b,t) are considered.

sum(l,alloc_{b,p,l,t})≦buy_{b}*inv_share_{b,p}*delivery_rate_{b}∀(b,p),t (23)

3. Total buy requirement—should buy enough to satisfy total impression buy requirement for each advertiser line and day t.

sum((b,p),alloc_{b,p,l,t}*usable_share_{b,l})≧buy_req_total_{l,t}∀l,t (24)

4. Targeted buy requirement—should buy enough to satisfy buy requirements for targeted inventory.

sum((b,p),alloc_{b,p,l,t}*usable_share_{b,l}*prob_in_tgt_{b,p,l})≧buy_req_skew_{l,t}∀l,t (25)

5. ATF buy requirement—should buy enough to satisfy buy requirements for targeted inventory.

sum((b,p),alloc_{b,p,l,t}*usable_share_{b,l}*atf_pct_{b})≧buy_req_atf_{l,t}∀l,t (26)

6. Logical constraint #1—set binary variable indicating whether or not a purchase is made from a publisher u. Only publishers u associated with candidate buys b are considered.

buy_{b}≦M*yᵤ∀b,u (27)

where M is a fixed large number that is larger than any buy_{b},

7. Logical constraint #2—set binary variable indicating whether or not site s is bought for advertiser line l.

sum((p,t),alloc_{b,p,l,t})≦M*z_{s,l}∀s,l (28)

where M is a fixed large number that is larger than any sum((p,t),alloc_{b,p,l,t}).

8. Purchase consolidation constraint—the number of different publishers from whom inventory is purchased should be less than a user-specified number; yu is a binary variable that equals 1 if there is a purchase from publisher u.

sum(u,yᵤ)≦max_num_purchase_orders (29)

9. Site breadth constraint—should buy some minimum number of sites s for each advertiser line l; z_{s,1} is a binary variable that equals 1 if site s is bought for advertiser line 1.

sum(s,z_{s,l})≧min_site_breadthₗ∀l (30)

It is appreciated that in the above formulation, the business constraint involving targeting (constraint No. 4) can be expressed in terms of unique visitors, as opposed to number of impressions.

As is the case with Allocation Optimization Module 400, partitioning inventory can yield improved solutions in situations where campaigns have demographic/geographic targeting restrictions. Consider the example where there is a positive buy requirement for some number of California-only impressions. Without partitioning, Buy Plan Optimization Module 405 would recommend buying inventory explicitly guaranteed to be California-only. This kind of explicitly targeted inventory may be either expensive or not easily purchased.

A better solution might be to buy untargeted inventory and then apply the California portion of those impressions to the California buy requirement. This is similar to the partitioning step in Allocation Optimization Module 400. Accordingly, the partitioning implemented in Allocation Optimization Module 400 can be applied to identify useful partitions of inventory in Buy Plan Optimization Module 405 (805).

Shadow prices can be obtained from Buy Optimization Module 405 mixed-integer program by fixing the binary variables at their optimal values and re-solving the problem as a linear program (810). If no useful partitions are found, or if another termination criterion is met, the optimized buy plan is reported to the user (815). The user may override the recommended plan as appropriate in the web-enabled user interface. The final, approved buy plan is then persisted in database 385.

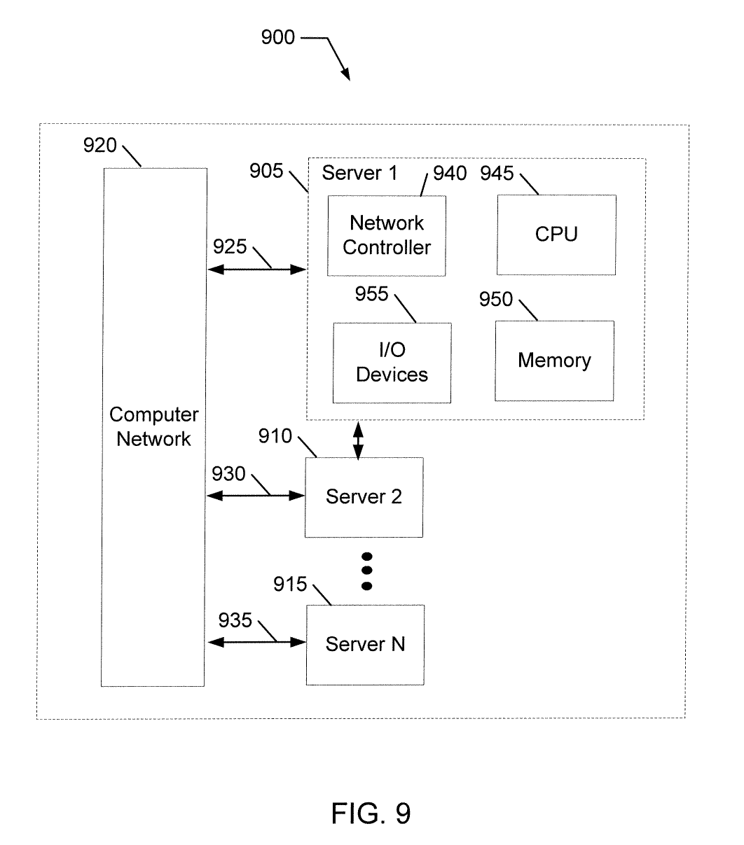

The ad network system 100 of FIG. 1 and its components and operations described with reference to FIGS. 2-8 can be implemented using computer system 900 shown in FIG. 9. Computer system 900 may include one or more computer servers 905-915 that are connected to computer network 920, e.g., the Internet, via computer buses 925-935. Computer servers 905-915 may be any computer server known to one skilled in the art, and may include components such as network controller 940, CPU 945, memory 950, I/O devices 955 (e.g., keyboard, mouse, touch screen, monitor, printer, and the like, not shown), and so on.

Advantageously, the ad network system of embodiments of the invention enables advertisers to determine optimized purchase requirements for multiple advertising campaigns such that their business goals are met at a minimum cost. In particular, optimized purchase requirements are made seamlessly by the ad network while allowing flexible specification of various campaign qualifiers, constraints, and quality controls.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. An ad network system for optimizing the purchase of online display advertisement inventory, comprising:
an advertiser management system to manage and acquire data for a set of advertising campaigns for a set of advertisers;
a publisher management system to manage and acquire data for inventory at publishers' sites and applications; and
a media buying system to run a two-part optimization to determine an allocation of available inventory and an inventory purchase plan based on the data acquired by the advertiser management system and the publisher management system.

2. The ad network system of claim 1, wherein the data acquired by the advertiser management system comprises a set of requirements, guarantees, qualifiers and delivery data for the set of advertising campaigns.

3. The ad network system of claim 2, wherein an advertising campaign from the set of advertising campaigns comprises multiple guarantees, with multiple channels and flights within each guarantee.

4. The ad network system of claim 1, wherein the data acquired by the publisher management system comprises data describing inventory already purchased and inventory that can be purchased from the publishers' sites and applications.

5. The ad network system of claim 1, wherein the media buying system forecasts impressions from inventory that has already been purchased.

6. The ad network system of claim 5, wherein forecasting of the impressions is implemented with a Kalman filter.

7. The ad network system of claim 1, further comprising a user interface to enable a user to specify business rules, campaign performance goals, and targeting requirements for the set of advertising campaigns.

8. The ad network system of claim 1, wherein the two-part optimization comprises an allocation optimization module and a buy plan optimization module.

9. The ad network system of claim 8, wherein the allocation optimization module determines a set of buy requirements for each advertising campaign in the set of advertising campaigns.

10. The ad network system of claim 9, wherein the allocation optimization module minimizes a cost of incremental inventory buys plus penalties due to constraint violations for the set of advertising campaigns.

11. The ad network system of claim 10, wherein the allocation optimization module partitions inventory from one or more inventory lines to generate the set of buy requirements.

12. The ad network system of claim 9, wherein the buy plan optimization module generates the inventory purchase plan to satisfy the set of buy requirements.

13. A method for optimizing the purchase of online display advertising in an ad network system, the method comprising:
in the ad network system,
acquiring data for a set of advertising campaigns managed by the ad network;
acquiring inventory data for publishers' sites and applications;
determining a set of inventory purchase requirements for the set of advertising campaigns;
segmenting one or more inventory lines along one or more dimensions to revise the set of inventory purchase requirements; and
determining an inventory purchase plan to satisfy the set of inventory purchase requirements.

14. The method of claim 13, wherein acquiring the data for the set of advertising campaigns comprises acquiring a set of requirements, guarantees, qualifiers and delivery data for the set of advertising campaigns.

15. The method of claim 13, wherein acquiring the inventory data comprises acquiring data describing inventory already purchased and inventory that can be purchased from the publishers' sites and applications.

16. The method of claim 13, further comprising forecasting impressions from inventory that has already been purchased by the ad network system.

17. The method of claim 13, wherein determining the set of inventory purchase requirements comprises determining a minimum cost of incremental inventory buys in a linear programming optimization.

18. The method of claim 13, wherein determining an inventory purchase plan comprises minimizing a total purchase cost in a mixed integer programming optimization.

19. A computer server implementing a two-part optimization module for optimizing the purchase of online display advertisement inventory in an ad network, the two-part optimization module comprising:
an allocation optimization module comprising linear programming executable routines to:
receive advertising campaign data and inventory data collected in the ad network;
generate a set of inventory purchase requirements for a set of advertising campaigns; and
revise the set of inventory purchase requirements by segmenting one or more inventory lines along one or more dimensions; and
a buy plan optimization module to determine an inventory purchase plan to satisfy the set of inventory purchase requirements.

20. The computer server of claim 19, wherein inventory can be purchased directly from publishers' sites and applications and from blind channels.
